(19) United States
(12) Patent Application Publication
(10) Pub. No.: US 2013/0335413 A1
(43) Pub. Date: Dec. 19, 2013

(54) SYSTEM AND METHOD FOR ESTIMATING CONSTRUCTION DURATION

(71) Applicants: Wei-Chih Wang, Hsinchu City (TW); Cheng-Yi Chen, Hsinchu City (TW); Shao-Wei Weng, Hsinchu City (TW)

(72) Inventors: Wei-Chih Wang, Hsinchu City (TW); Cheng-Yi Chen, Hsinchu City (TW); Shao-Wei Weng, Hsinchu City (TW)

(73) Assignee: NATIONAL CHIAO TUNG UNIVERSITY, Hsinchu City (TW)

(21) Appl. No.: 13/495,286

(22) Filed: Jun. 13, 2012

(51) Int. Cl. G06T 17/00

(52) U.S. Cl. 345/420

(57) ABSTRACT

A system and method for estimating construction duration. The system includes a three-dimensional (3D) building information model (BIM) module, a duration estimation module, and a 4D BIM module. The 3D BIM module constructs a 3D BIM based on inputted modeling instructions and generates quantity information corresponding to the 3D BIM. The duration estimation module calculates duration information for construction work based on inputted construction condition information and the quantity information of the 3D BIM produced. The 4D BIM module constructs a 4D BIM based on the 3D BIM and the duration information. Thus, the present invention can automatically calculate the quantity of building materials, estimate the construction duration, establish a construction progress table, and demonstrate the construction progress of the 4D BIM in an animated way, replacing the traditional way of manually processing information for duration estimation.

### BACKGROUND OF THE INVENTION

1. Field of the Invention

The present invention relates to techniques for estimating construction duration, and, more particularly, to a system and method for estimating construction duration in the construction related industry.

2. Description of Related Art

The life cycle of a construction project basically involves a planning/designing stage, a construction stage and an operation/maintenance stage. In the construction stage, a construction plan must be established so that an engineering project can be carried out successfully to achieve the desired quality and meet objectives in a construction schedule. The construction plan of an engineering project may include an operating schedule and progress plan, a sub-project plan, a resource statistics and management plan etc. Although in practice construction plans are proposed before the construction begins, they often turn out to be a mere formality and cannot be implemented effectively for the management of engineering constructions.

The construction plan needs to be modified to meet the current construction status during the construction stage, and decisions about the number of workers, equipment, overtime hours and the like are made according to the construction planning The decisions are used as the basis of estimation of the construction duration, so as to ensure that the modified construction plan can be completed on schedule. However, in practice, the estimation of the construction duration still mainly relies on human experiences and judgments. Without a reliable estimation scheme, establishment of various construction plans and decision-making are difficult to be implemented effectively, resulting in lengthening of the construction duration. This is a common problem in the construction industry. Therefore, whether a construction plan can be successfully completed on schedule often depends on whether the project team is equipped with a good model for estimating the construction duration.

In view of the above background, the problems are discussed in two aspects.

1. Estimation results of the construction duration and construction plans are not convincing due to the lack of a standard procedure and method for estimating the construction duration: project schedule is the main focus of the overall project plan. With the increasing scale of the projects and finer specializations, factors to be considered in estimating the construction duration are becoming more complicated. In practice, the estimation is often done by managerial personnel based on their experiences and knowledge, and the duration of the projection is manually calculated. However, this kind of estimation method often overlooks the influential factors of different aspects (e.g., resources or time) of the project, therefore fails to reflect the actual restrictions and requirements during implementations. Moreover, the contents of this type of estimation are often too coarse, such that establishing a construction schedule easily becomes a mere formality and cannot be implemented effectively for the management of engineering constructions.

2. It is difficult to ensure the correctness and timeliness of information due to the lack of an information converting interface: when the projects enters from the design stage to the construction stage, managerial stuff has to understand the contents described in the engineering drawings, analyze related construction information based on the drawings and contract documents to formulate any project plan and to facilitate the execution and promotion of the projects. However, traditionally, information is processed manually, since a good information converting interface is not available, during the analysis of the engineering information, one has to imagine construction characteristics and spatial associations of various construction elements in the drawing in an abstract way. These massive and complicated information processing tasks are not only time-consuming and labor-intensive, but are not often not accurate and timely enough.

Therefore, there is a need for a solution that solves the above shortcomings of the prior art.

### SUMMARY OF THE INVENTION

In light of the foregoing drawbacks, the present invention provides a system and method for estimating construction duration. With a 3D BIM, a duration estimation module, a progress evaluating module and the like, the procedure for calculating the quantity of building materials, estimating the construction duration, and establishing a construction progress table can be automated, replacing the traditional way of manually processing information for duration estimation. A good information converting interface is also provided to ensure the correctness and timeliness of the information.

The present invention proposes a system for estimating construction duration, which may at least include a three-dimensional building information model (3D BIM) module, a duration estimation module and a 4D BIM module.

The 3D BIM module can be used for constructing a 3D BIM based on inputted modeling instructions and generating quantity information corresponding to the 3D BIM, wherein the quantity information includes at least one of the number of reinforcements for columns, walls, beams, or plates in each floor, the number of molds, and the quantity of concrete.

The duration estimation module can be used for calculating duration information for construction work based on inputted construction condition information and the quantity information of the 3D BIM produced by the 3D BIM module, wherein the construction condition information may include at least one of work rate, the number of workers, overtime hours, the number of molds, the number of equipment, and the number of cranes, and the duration information may include at least one of the total construction duration, breakdown of duration of each construction task, the most optimistic duration, the most pessimistic duration, and the most likely duration.

The 4D BIM module can be used for constructing a 4D BIM based on the 3D BIM produced by the 3D BIM module and the duration information calculated by the duration estimation module. A construction progress of the 4D BIM can be demonstrated in an animated way.

The duration estimation module described above may further include a computer simulating unit for generating the duration information by performing simulation calculations based on the construction condition information and the quantity information.

The system for estimating construction duration may further include a database for storing the quantity information.

The system for estimating construction duration may further include a progress evaluating module for generating a construction progress table based on the duration information, such that the 4D BIM module constructs the 4D BIM based on the 3D BIM and the construction progress table, wherein the construction progress table may include at least one of a pre-task, a task name, a duration, a start time, an end time, an average time, a minimum time, a maximum time and a waiting time.

The present invention also proposes a method for estimating construction duration, which may at least include the following steps of: (1) constructing a 3D BIM based on inputted modeling instructions and generate quantity information corresponding to the 3D BIM; (2) calculating duration information for construction work based on inputted construction condition information and the quantity information of the 3D BIM; and (3) constructing a 4D BIM based on the 3D BIM and the duration information.

In an embodiment, the step (2) of the method for estimating construction duration according to the present invention may further include: (2-1) storing the quantity information; (2-2) generating a quantity list based on the quantity information; (2-3) generating the duration information by performing simulation calculations based on the construction condition information and the quantity information; and (2-4) generating a construction progress table based on the duration information, wherein the construction progress table may include at least one of a pre-task, a task name, a duration, a start time, an end time, an average time, a minimum time, a maximum time and a waiting time.

In an embodiment, the step (3) of the method for estimating construction duration according to the present invention may further include: (3-1) constructing the 4D BIM based on the 3D BIM and the duration information; and (3-2) demonstrating a construction progress of the 4D BIM of in an animated way.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram illustrating a system for estimating construction duration according to the present invention; and

FIG. 2 is a flowchart illustrating the steps of a method for estimating construction duration according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

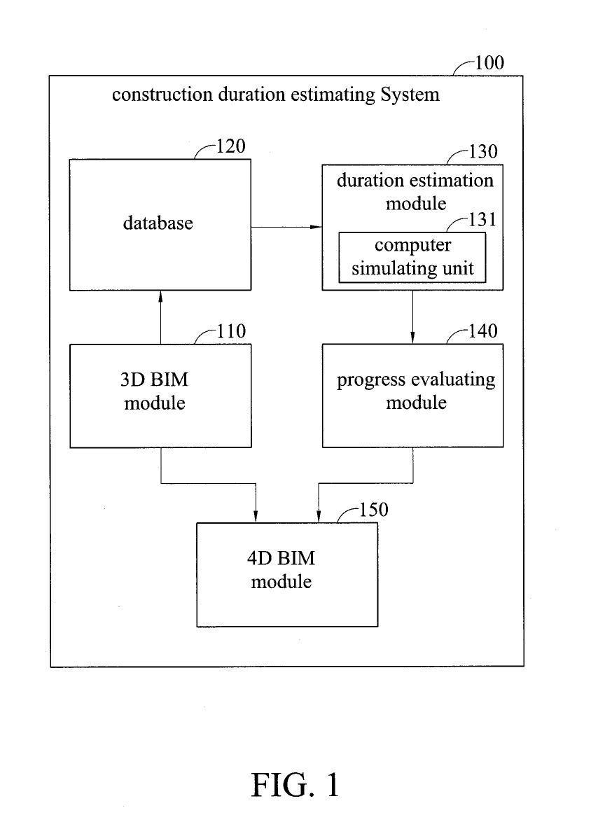

Referring to FIG. 1, a block diagram illustrating a system for estimating construction duration 100 is shown. As shown, the system for estimating construction duration 100 at least includes a 3D building information modeling (BIM) module 110, a duration estimation module 130 and a 4D BIM module 150.

The 3D BIM module 110 constructs a 3D building information model based on modeling instructions inputted by users, and generates quantity information corresponding to the 3D BIM. The 3D BIM module 110 can be a 3D BIM software or 3D BIM program. The contents of the 3D BIM may include graphical or non-graphical information of the building, such as the quantity information, engineering drawings, geometric shapes, spatial relationships or geographic information etc. of the building. The quantity information may include the number of reinforcements for columns, walls, beams, and plates in each floor, the number of molds or the quantity of concrete and the like.

The duration estimation module 130 calculates duration information for the construction work based on construction condition information input by the users and the quantity information of the 3D BIM. The duration estimation module 130 can be duration estimation software or a duration estimation program for structural engineering. The construction condition information may include work rate, the number of workers, overtime hours, the number of molds, the number of equipment, the number of cranes and so on. The duration information may include total construction duration, breakdown of duration of various construction tasks, as well as the most optimistic duration, the most pessimistic duration, and the most likely duration.

The 4D BIM module 150 constructs a 4D building information model based on the 3D BIM produced by the 3D BIM module 110 and the duration information produced by the duration estimation module 130. The progress of construction of the 4D BIM can be demonstrated in an animated way.

The duration estimation module 130 may further include a computer simulating unit 131 for generating the duration information by performing simulation calculations based on the construction condition information and the quantity information. The computer simulating unit 131 may be computer simulating software or a computer simulating program.

The system for estimating construction duration 100 may further include a database 120 for storing the quantity information corresponding to the 3D BIM. Thus, the duration estimation module 130 may read the quantity information corresponding to the 3D BIM from the database 120, and generate a quantity list to be viewed by the users based on the number of reinforcements for columns, walls, beams, and plates in each floor, the number of molds or the quantity of concrete and the like. The database 120 can be a joint database, a central database etc.

The system for estimating construction duration 100 may also include a progress evaluating module 140 for generating a construction progress table based on the duration information, allowing the 4D BIM module 150 to construct the 4D BIM from the 3D BIM and the construction progress table. The progress evaluating module 140 may automatically generate the construction progress table for project management software, or the construction progress table can be imported into the project management software to facilitate control and management of the construction progress.

The construction progress table may include (A) pre-tasks, task names, duration, start time and end time for each construction task; (B) the average time, the minimum time and the maximum time of multiple computer simulations; and (C) waiting times for reinforcement work, molding work and cranes

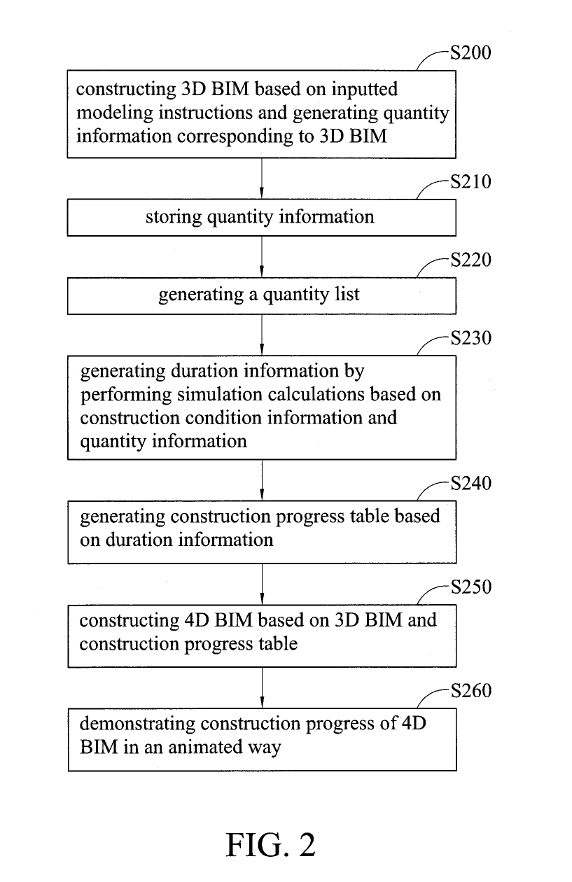

Referring to FIG. 2, a flowchart illustrating the steps of a method for estimating construction duration is shown.

In step S200, the 3D BIM module is enabled to construct a 3D building information model based on modeling instructions inputted by users, and generate quantity information corresponding to the 3D BIM, wherein the 3D BIM module can be a 3D BIM software or 3D BIM program. The contents of the 3D BIM may include graphical or non-graphical information of the building, such as the quantity information, engineering drawings, geometric shapes, spatial relationships or geographic information etc. of the building. The quantity information may include the number of reinforcements for columns, walls, beams, and plates in each floor, the number of molds or the quantity of concrete and the like. Then, the method proceeds to step S210.

In step 210, the database is enabled to store the quantity information corresponding to the 3D BIM. The database can be a joint database, a central database etc. Then, the method proceeds to step S220.

In step 220, the duration estimation module is enabled to calculate duration information for the construction work based on construction condition information input by the users and the quantity information of the 3D BIM, and generate a quantity list to be viewed by the users based on the number of reinforcements for columns, walls, beams, and plates in each floor, the number of molds or the quantity of concrete and the like. Then, the method proceeds to step S230.

In step 230, the computer simulating unit of the duration estimation module is enabled to generate the duration information by performing simulation calculations based on the construction condition information input by the users and the quantity information corresponding to the 3D BIM, wherein the duration estimation module can be duration estimation software or a duration estimation program for structural engineering, the construction condition information may include work rate, the number of workers, overtime hours, the number of molds, the number of equipment, the number of cranes and so on, and the duration information may include total construction duration, breakdown of duration of various construction tasks, as well as the most optimistic duration, the most pessimistic duration, and the most likely duration. Then, the method proceeds to step S240.

In step 240, the progress evaluating module is enabled to generate a construction progress table based on the duration information, wherein the progress evaluating module may automatically generate the construction progress table for project management software, or the construction progress table can be imported into the project management software to facilitate control and management of the construction progress. The construction progress table may include (A) pre-tasks, task names, duration, start time and end time for each construction task; (B) the average time, the minimum time and the maximum time of multiple computer simulations; and (C) waiting times for reinforcement work, molding work and cranes. Then, the method proceeds to step S250.

In step S250, the 4D BIM module is enabled to construct the construction progress of a 4D building information model in an animated way.

In summary, the system and method for estimating construction duration according to the present invention has at least the following effects:

1. With the 3D BIM, the database, the duration estimation module and the progress evaluating module, the procedure for calculating the quantity of the building materials, estimating the construction duration, and establishing the construction progress table can be automated, replacing the traditional way of manually processing information for duration estimation. Meanwhile, a standard procedure and method for estimating duration is established, such that the results of estimation and contents of construction plans are more convincing.

2. By automatically generating the quantity information corresponding to the 3D BIM, and converting it into the quantity list, the duration information, the construction progress table and the 4D BIM, a good information converting interface is provided to ensure the correctness and timeliness of the information.

3. By constructing the 4D BIM using the 3D BIM and the construction progress table, construction progress of the 4D BIM can be shown as an animation, so that the users can more clearly understand the construction duration and progression of each floors and for each construction tasks.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A system for estimating construction duration, comprising:
a three-dimensional building information model module for constructing a three-dimensional building information (3D BIM) based on inputted modeling instructions, and generating quantity information corresponding to the 3D BIM;
a duration estimation module for calculating duration information for construction work based on inputted construction condition information and the quantity information of the 3D BIM produced by the 3D BIM module; and
a four-dimensional (4D) BIM module for constructing a 4D BIM based on the 3D BIM produced by the 3D BIM module and the duration information calculated by the duration estimation module.

2. The system of claim 1, wherein the quantity information includes at least one of the number of reinforcements for columns, walls, beams, or plates in each floor, the number of molds, and the quantity of concrete.

3. The system of claim 1, wherein the construction condition information includes at least one of work rate, the number of workers, overtime hours, the number of molds, the number of equipment, and the number of cranes.

4. The system of claim 1, wherein the duration information includes at least one of the total construction duration, breakdown of duration of each construction task, the most optimistic duration, the most pessimistic duration, and the most likely duration.

5. The system of claim 1, wherein the duration estimation module generates a quantity list based on the quantity information.

6. The system of claim 1, wherein the duration estimation module further includes a computer simulating unit for generating the duration information by performing simulation calculations based on the construction condition information and the quantity information.

7. The system of claim 1, wherein the 4D BIM module demonstrates a construction progress of the 4D BIM in an animated way.

8. The system of claim 1, further comprising a database for storing the quantity information.

9. The system of claim 1, further comprising a progress evaluating module for generating a construction progress table based on the duration information, such that the 4D BIM module constructs the 4D BIM based on the 3D BIM and the construction progress table.

10. The system of claim 9, wherein the construction progress table includes at least one of a pre-task, a task name, a duration, a start time, an end time, an average time, a minimum time, a maximum time and a waiting time.

11. A method for estimating construction duration, comprising:
constructing a 3D BIM based on inputted modeling instructions and generating quantity information corresponding to the 3D BIM;
calculating duration information for construction work based on inputted construction condition information and the quantity information of the 3D BIM; and
constructing a 4D BIM based on the 3D BIM and the duration information calculated.

12. The method of claim 11, wherein the quantity information includes at least one of the number of reinforcements for columns, walls, beams, or plates in each floor, the number of molds, and the quantity of concrete.

13. The method of claim 11, further comprising storing the quantity information.

14. The method of claim 11, further comprising generating a quantity list based on the quantity information.

15. The method of claim 11, further comprising generating the duration information by performing simulation calculations based on the construction condition information and the quantity information.

16. The method of claim 11, further comprising generating a construction progress table based on the duration information, and constructing the 4D BIM based on the 3D BIM and the construction progress table.

17. The method of claim 16, wherein the construction progress table includes at least one of a pre-task, a task name, a duration, a start time, an end time, an average time, a minimum time, a maximum time and a waiting time.

18. The method of claim 11, further comprising demonstrating a construction progress of the 4D BIM in an animated way.
